(19) United States
(12) Patent Application Publication
(10) Pub. No.: US 2007/0183759 A1
(43) Pub. Date: Aug. 9, 2007

(54) Image capture device object template

(76) Inventor: Kum Wai Wan, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/349,563

(22) Filed: Feb. 8, 2006

(51) Int. Cl. G03B 15/00

(52) U.S. Cl. 396/5

(57) ABSTRACT

A template for an image capture device comprises a body having at least one support member for supporting at least one object, the at least one support member movable relative to the body to facilitate movement of the at least one object toward a platen of the image capture device for imaging thereof.

### BACKGROUND OF THE INVENTION

Templates for supporting one or more objects on an image capture device are employed to align objects on the image capture device and/or to enable the objects to be carried on the template during placement on and/or removal from the image capture device. For example, when it is desired to image objects such as slides, a user places the slides on the template and the template is then positioned on the image capture device for imaging. However, such templates generally have a detrimental effect on image quality at least because the location of the object plane (e.g., the object plane of the slide) does not coincide with a focal plane of the optics of the image capture device.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a diagram illustrating an embodiment of a template for an image capture device in accordance with an embodiment of the present invention;

FIG. 2A is a diagram illustrating a section view taken of the template illustrated in FIG. 1 taken along the line 2-2 of FIG. 1 with a cover of the image capture device in an open position; and

FIG. 2B is a diagram illustrating a section view of the template illustrated in FIG. 1 taken along the line 2-2 of FIG. 1 with the cover of the image capture device in a closed position.

### DETAILED DESCRIPTION OF THE DRAWINGS

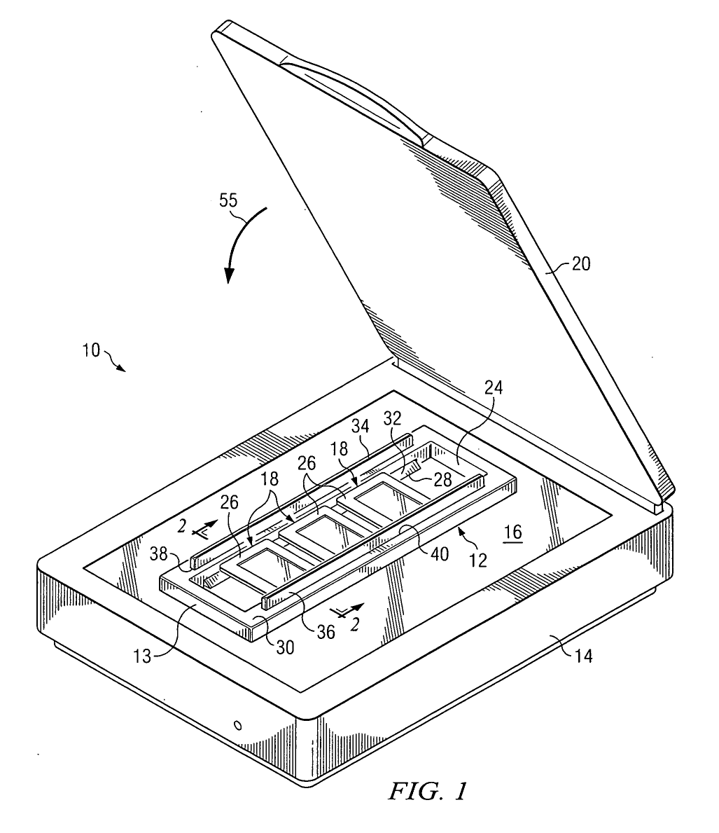

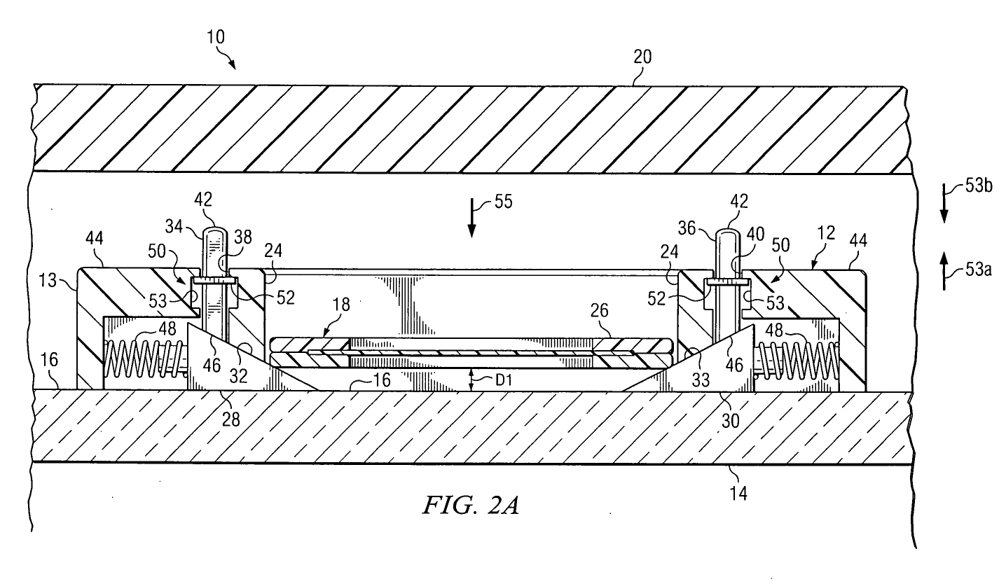

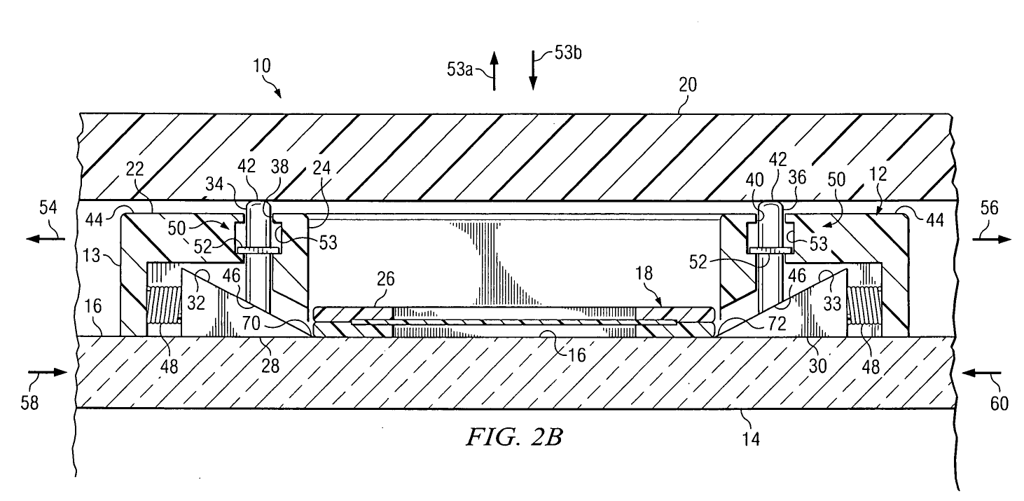

The preferred embodiments of the present invention and the advantages thereof are best understood by referring to FIGS. 1-2B of the drawings, like numerals being used for like and corresponding parts of the various drawings.

FIG. 1 is a diagram illustrating an embodiment of a template 12 in accordance with the present invention used with an image capture device 10. In the embodiment illustrated in FIG. 1, image capture device 10 comprises a scanner 14 having a transparent platen 16 for supporting thereagainst at least one object 18 to be scanned. Scanner 14 comprises a cover 20 that is placed over objects 18 during scanning. It should be understood that image capture device 10 may comprise other types of imaging devices, including, but not limited to, facsimile machines, photocopiers, printers and multi-purpose devices.

In the embodiment illustrated in FIG. 1, a single template 12 is disposed on platen 16 for supporting a plurality of objects 18. It should be understood that a greater number of templates 12 can be placed on platen 16 depending on the size of platen 16 and/or the number of objects 18 desired to be imaged. In the embodiment illustrated in FIG. 1, template 12 comprises a body 13 having at least one slot 24 formed therein and sized to receive and support object(s) 18. In the embodiment illustrated in FIG. 1, object(s) 18 comprise one or more slides 26 supported within slot 24; however, it should be understood that other types of objects 18 can be disposed within slot 24. Further, it should be understood that slot 24 can be any width or shape to accommodate different types and/or shapes of objects 18, and each template 12 may be manufactured having a greater number of slots 24 thereon.

In the embodiment illustrated in FIG. 1, template 12 comprises retractable support members 28 and 30 extending into slot 24. Support members 28 and 30 support object(s) 18 on a sloped top surface 32 and 33 thereof, respectively, such that template 12 and object(s) 18 can be lifted from and/or placed onto image capture device 10 while supported by template 12. In the embodiment illustrated in FIG. 1, each template 12 comprises a pair of push rods 34 and 36 disposed with a pair of openings 38 and 40, respectively. In operation, push rods 34 and 36 are depressable into openings 38 and 40 to cause support members 28 and 30 to retract relative to slot 24, thereby enabling object(s) 18 to move downward along sloped top surfaces 32 and 33 so as to cause object(s) 18 to rest on or substantially adjacent to platen 16. In the embodiment illustrated in FIG. 1, two support members 28 and 30 are illustrated. However, it should be understood that a greater or fewer quantity of support members may be used.

FIG. 2A is a diagram illustrating a section with of template 12 illustrated in FIG. 1 taken along the line 2-2 of FIG. 1. In FIG. 2A, template 12 is disposed on platen 16 and a cover 20 of image capture device 10 is illustrated in a slightly open position. In the embodiment illustrated in FIG. 2A, push rods 34 and 36 each comprise a first end 42 extending above a top surface 44 of template 12 to facilitate engagement therewith by cover 10 in response to lowering and/or closing cover 10 of image capture device 10. Push rods 34 and 36 further each comprise a second end 46 in slidable engagement with support members 28 and 30. In the embodiment illustrated in FIG. 2A, a biasing mechanism 48 biases each support member 28 and 30 inwardly toward slot 24 and object(s) 18 (e.g., in an extended position), thereby causing first ends 42 to protrude above top surface 44 of template 12. In the embodiment illustrated in FIG. 2A, template 12 comprises a stopper system 50 to secure rods 34 and 36 and limit travel within respective openings 38 and 40. In the embodiment illustrated in FIG. 2A, stopper system 50 comprises a protrusion 52 extending outwardly from push rods 34 and 36 and movable within a slot 53 to limit travel of push rods 34 and 36 inside slot 53 in the directions indicted by arrows 53a and 53b and, correspondingly, limit travel of support members 28 and 30 relative to slot 24.

In operation, object(s) 18 are inserted within slot 24, and template 12 is placed on platen 16. As illustrated in FIG. 2A, support members 28 and 30 support object(s) 18 above platen 16 a predetermined distance “D1.” Preferably, template 12 is configured such that the distance D1 corresponds generally to the distance that push rods 34 and 36 extend above top surface 44. In response to closing of cover 20 relative to template 12 (e.g., rotation of cover 20 in the direction indicated by arrow 55 (FIG. 1)), cover 20 engages push rods 36 and 36 and exerts a downward force on push rods 34 and 36, thereby overcoming the biasing force of biasing mechanisms 48 and moving push rods 34 and 36 downwardly to slightly above or flush with top surface 44 and causing movement of support members 28 and 30 to retract away from slot 24.

FIG. 2B is a diagram illustrating a section view of template 12 illustrated in FIG. 1 taken along the line 2-2 of FIG. 1 with cover 20 in a closed position (e.g., cover 20 disposed over and onto template 12). In the embodiment illustrated in FIG. 2B, cover 20 engages first ends 42 of push rods 34 and 36 to depress push rods 34 and 36 to a position slightly above or flush with surface 44. As push rods 34 and 36 are pushed downwardly by cover 20, second ends 46 push downwardly on sloped top surfaces 32 and 33 of respective support members 28 and 30 causing support members 28 and 30 to retract in the directions indicated by arrows 54 and 56. In response to retraction of support members 28 and 30, object(s) 18 travel downward along sloped top surfaces 32 and 33 toward platen 16 until object(s) 18 are disposed on or slightly above platen 16. For example, retraction of support members 28 and 30 preferably releases object(s) 18 from being supported by supported members 28 and 30, thereby enabling object(s) 18 to be lowered or dropped onto platen 16. However, it should be understood that object(s) 18 may be disposed slightly above platen 16 in response to partial retraction of support members 28 and 30. Accordingly, as cover 30 placed over and onto template 12, object(s) 18 are automatically moved and/or lowered within slot 24 to position object(s) 18 on or slightly above platen 16 for scanning. Accordingly, as distance D1 (FIG. 2A) is reduced and/or eliminated, the quality of image of object(s) is enhanced as the location of the object plane is brought near or coincident with a focal plane of the optics of image capture device 10. In the embodiment illustrated in FIGS. 1, 2A and 2B, template 12 comprises two movable support members 28 and 30 and two corresponding push rods 34 and 36. However, it should be understood that template 12 may by configured with a greater or fewer quantity of movable support members and/or push rods. Further, in the embodiment illustrated in FIGS. 1, 2A and 2B, cover 20 is used to actuate push rods 34 and 36 to lower object(s) 18 onto or slightly above platen 16. However, it should be understood that other devices may be used to actuate push rods 34 and 36, including manually actuating push rods 34 and 36.

In response to opening of cover 20 relative to template 12, biasing mechanisms 48 exert an inwardly-directed force on respective support members 28 and 30 toward slot 24 causing support members 28 and 30 to return to an extended position and causing push rods 34 and 36 to travel upwardly within respective openings 38 and 40. As support members 28 and 30 return to the extended position, edge portions 70 and 72 of respective support members 28 and 30 travel under object(s) 18 and lift object(s) 18 upwardly to raising object(s) 18 above platen 16, thereby resulting in object(s) 18 being supported by support members 28 and 30. Template 12 may be removed from platen 16 with object(s) 18 along therewith.

Thus, embodiments of the present invention enable object(s) 18 to be disposed on a template 12 and supported by the template during placement on and/or removal from an image capture device 10. Further, embodiments of the present invention enable object(s) 18 disposed on template 12 to be automatically moved closer to and/or onto platen 16 for imaging thereof (e.g., in response to closing of cover 20 over template 12), thereby reducing and/or eliminating the distance between object(s) 18 and platen 16 and improving imaging quality.

What is claimed is:

1. A template for an image capture device, comprising:
a body having at least one support member for supporting at least one object, the at least one support member movable relative to the body to facilitate movement of the at least one object toward a platen of the image capture device for imaging thereof.

2. The template of claim 1, wherein the at least one support member is movable in response to a cover of the imaging device engaging the template.

3. The template of claim 1, wherein the at least one support member is movable relative to the body to facilitate movement of the at least one object onto the platen.

4. The template of claim 1, wherein the at least one support member is biased towards the at least one object.

5. The template of claim 1, wherein the body comprises at least one slot for receiving the object.

6. The template of claim 5, wherein the at least one support member is retractable relative to the at least one slot.

7. The template of claim 1, wherein the at least one support member is movable in response to depressing of a push rod coupled thereto.

8. The template of claim 1, wherein movement of the at least one support member releases the at least one object from being supported by the at least one support member.

9. A template for an image capture device, comprising:
body means having at least one means for supporting at least one object, the at least one support means movable relative to the body means to facilitate movement of the at least one object toward a platen of the image capture device for imaging thereof.

10. The template of claim 9, wherein the at least one support means is movable in response to a cover means of the imaging device engaging the template.

11. The template of claim 9, wherein the at least one support means is movable relative to the body means to facilitate movement of the at least one object onto the platen.

12. The template of claim 9, further comprising a biasing means for biasing the at least one support means towards the at least one object.

13. The template of claim 9, further comprising a means for moving the at least one support means in response to depressing the moving means.

14. A method of manufacturing a template for an image capture device, comprising:
providing a body having at least one support member for supporting at least one object, the at least one support member movable relative to the body to facilitate movement of the at least one object toward a platen of the image capture device for imaging thereof.

15. The template of claim 14, further comprising configuring the at least one support member to be movable in response to a cover of the imaging device engaging the template.

16. The template of claim 14, further comprising configuring the at least one support member to be movable relative to the body to facilitate movement of the at least one object onto the platen.

17. The template of claim 14, further comprising providing a biasing mechanism to bias the at least one support member towards the at least one object.

18. The template of claim 14, further comprising providing at least one slot in the body for receiving the object.

19. The template of claim 18, further comprising configuring the at least one support member to be retractable relative to the at least one slot.

20. The template of claim 14, further comprising providing at least one depressable push rod for causing movement of the at least one support member.

21. The template of claim 14, further comprising configuring the at least one support member to release the at least one object from being supported thereby.
